(19) United States
(12) Patent Application Publication
(10) Pub. No.: US 2026/0100792 A1
(43) Pub. Date: Apr. 9, 2026

(54) METHOD AND APPARATUS FOR TRANSMITTING A SIGNAL IN WIRELESS COMMUNICATION SYSTEM

(71) Applicant: ELECTRONICS AND TELECOMMUNICATIONS RESEARCH INSTITUTE, Daejeon (KR)

(72) Inventors: Kapseok CHANG, Daejeon (KR); Hoiyoon JUNG, Daejeon (KR); Young Jo KO, Daejeon (KR); Yong Sun KIM, Daejeon (KR); Junghoon LEE, Daejeon (KR)

(73) Assignee: ELECTRONICS AND TELECOMMUNICATIONS RESEARCH INSTITUTE, Daejeon (KR)

(21) Appl. No.: 19/350,346

(22) Filed: Oct. 6, 2025

(30) Foreign Application Priority Data
Oct. 8, 2024 (KR) 10-2024-0136538
Oct. 2, 2025 (KR) 10-2025-0145121

(51) Int. Cl. H04L 5/00

(52) U.S. Cl. CPC H04L 5/0048

(57) ABSTRACT

A method of a terminal may comprise: receiving, from a base station, a carrier wave signal including subcarriers belonging to a sensing group within a system bandwidth; modulating pre-collected information based on receiving the carrier wave signal; and backscattering, to the base station, the carrier wave signal including the subcarriers of the sensing group, wherein at least one subcarrier among the subcarriers of the sensing group transmitted through the backscattered carrier wave signal includes the modulated information, and the subcarriers of the sensing group include a data-transmission subcarrier on which the modulated information is transmitted and a non-data-transmission subcarrier on which the modulated information is not transmitted.

### CROSS-REFERENCE TO RELATED APPLICATIONS

This application claims priority to Korean Patent Applications No. 10-2024-0136538, filed on Oct. 8, 2024, and No. 10-2025-0145121, filed on Oct. 2, 2025, with the Korean Intellectual Property Office (KIPO), the entire contents of which are hereby incorporated by reference.

### BACKGROUND

### 1. Technical Field

The present disclosure relates to a signal transmission technique in a wireless communication system, and more particularly, to a signal transmission technique for integrated communication and sensing in the wireless communication system.

### 2. Related Art

Current wireless communication systems are generally configured to transmit and receive signals based on an orthogonal frequency division multiplexing (OFDM) scheme. For example, Long Term Evolution (LTE), LTE-Advanced (LTE-A), Wi-Fi, and 5G New Radio (NR) systems are wireless communication systems based on the OFDM scheme.

In a mobile communication system, a network may transmit information to a user equipment (UE) and/or an Internet of Things (IoT) device by using one or more subcarrier groups among available subcarriers of an N-point inverse fast Fourier transform (IFFT) in the frequency domain. In this case, assuming that one subcarrier group corresponds to one physical resource block (PRB), information transmitted by the network to the UE and/or the IoT device may be transmitted through one or more PRBs.

A UE or IoT device that receives a signal including information from the network performs an N-point fast Fourier transform (FFT), selects PRBs allocated to the UE or IoT device, and restores the transmitted information.

In the wireless communication system operating as described above, the UE or IoT device needs to perform an FFT over the entire available frequency region to restore the allocated PRBs, which increases unnecessary power consumption. Because the UE or IoT device is generally powered by a battery, increased power consumption reduces the operating time of the UE or IoT device. In particular, IoT devices require low power consumption as well as low-complexity operation. Therefore, methods and apparatuses for transmitting a signal to a terminal requiring low power, such as an IoT device, are needed.

### SUMMARY

The present disclosure for resolving the above-described problems is directed to providing a method and an apparatus for transmitting signal to a terminal requiring low power consumption.

A method of a terminal, according to an exemplary embodiment of the present disclosure, may comprise: receiving, from a base station, a carrier wave signal including subcarriers belonging to a sensing group within a system bandwidth; modulating pre-collected information based on receiving the carrier wave signal; and backscattering, to the base station, the carrier wave signal including the subcarriers of the sensing group, wherein at least one subcarrier among the subcarriers of the sensing group transmitted through the backscattered carrier wave signal includes the modulated information, and the subcarriers of the sensing group include a data-transmission subcarrier on which the modulated information is transmitted and a non-data-transmission subcarrier on which the modulated information is not transmitted.

The modulated information may be transmitted in units of a predetermined symbol unit.

The pre-collected information may be configured as a bit string, each bit of the bit string may be modulated, and each bit of the bit string may have either a first value or a second value; based on a bit having the first value, the data-transmission subcarrier may be modulated to be shifted by a first frequency; and based on a bit having the second value, the data-transmission subcarrier may be modulated to be shifted by a second frequency.

The pre-collected information may be configured as a bit string, each bit of the bit string may be modulated, and each bit of the bit string may have either a first value or a second value; based on a bit having the first value, the bit having the first value may be modulated into a symbol corresponding to the second value and may be allocated to the data-transmission subcarrier; and based on a bit having the second value, the data-transmission subcarrier may be modulated to be shifted by a first frequency.

The pre-collected information may be configured as a bit string, each bit of the bit string may be modulated, and each bit of the bit string may have either a first value or a second value; based on a bit having the first value, first modulation may be performed such that the bit having the first value is modulated into a symbol corresponding to the second value, and second modulation may be performed such that the data-transmission subcarrier is modulated to be shifted by a first frequency; and based on a bit having the second value, third modulation may be performed such that the data-transmission subcarrier is modulated to be shifted by a second frequency.

The pre-collected information may be configured as a bit string, and each bit of the bit string may be modulated, and the backscattering may comprise: enabling or disabling a backscattering operation based on a value of each bit of the bit string.

The pre-collected information may be configured as a bit string, every two bits of the bit string are modulated, the two bits have one of a first value, a second value, a third value, or a fourth value; one or more values among the first value, the second value, the third value, or the fourth value may be modulated using two types of modulation schemes, and a symbol modulated for every two bits may be transmitted in units of a predetermined symbol unit.

The two types of modulation schemes may include at least one of an on-off keying (OOK) modulation scheme or an on-off 180-degree phase switching (OOPS) modulation scheme.

A terminal according to an exemplary embodiment of the present disclosure may comprise at least one processor, wherein the at least one processor may cause the terminal to perform: receiving, from a base station, a carrier wave signal including subcarriers belonging to a sensing group within a system bandwidth; modulating pre-collected information based on receiving the carrier wave signal; and backscattering, to the base station, the carrier wave signal including the subcarriers of the sensing group, wherein at least one subcarrier among the subcarriers of the sensing group transmitted through the backscattered carrier wave signal includes the modulated information, and the subcarriers of the sensing group include a data-transmission subcarrier on which the modulated information is transmitted and a non-data-transmission subcarrier on which the modulated information is not transmitted.

The modulated information may be transmitted in units of a predetermined symbol unit.

The pre-collected information may be configured as a bit string, each bit of the bit string may be modulated, and each bit of the bit string may have either a first value or a second value, and the at least one processor may further cause the terminal to perform: based on a bit having the first value, modulating the data-transmission subcarrier to be shifted by a first frequency; and based on a bit having the second value, modulating the data-transmission subcarrier to be shifted by a second frequency.

The pre-collected information may be configured as a bit string, each bit of the bit string may be modulated, and each bit of the bit string may have either a first value or a second value, and the at least one processor may further cause the terminal to perform: based on a bit having the first value, modulating the bit having the first value into a symbol corresponding to the second value and allocating the symbol to the data-transmission subcarrier; and based on a bit having the second value, modulating the data-transmission subcarrier to be shifted by a first frequency.

The pre-collected information may be configured as a bit string, each bit of the bit string may be modulated, and each bit of the bit string may have either a first value or a second value, and the at least one processor may further cause the terminal to perform: based on a bit having the first value, performing first modulation such that the bit having the first value is modulated into a symbol corresponding to the second value, and performing second modulation such that the data-transmission subcarrier is modulated to be shifted by a first frequency; and based on a bit having the second value, performing third modulation such that the data-transmission subcarrier is modulated to be shifted by a second frequency.

The pre-collected information may be configured as a bit string, each bit of the bit string may be modulated, and in the backscattering, the at least one processor may cause the terminal to perform: enabling or disabling a backscattering operation based on a value of each bit of the bit string.

The pre-collected information may be configured as a bit string, every two bits of the bit string may be modulated, the two bits may have one of a first value, a second value, a third value, or a fourth value, and the at least one processor may further cause the terminal to perform: modulating one or more values among the first value, the second value, the third value, or the fourth value using two types of modulation schemes, and transmitting a symbol modulated for every two bits in units of a predetermined symbol unit.

The two types of modulation schemes may include at least one of an on-off keying (OOK) modulation scheme or an on-off 180-degree phase switching (OOPS) modulation scheme.

A method of a base station, according to an exemplary embodiment of the present disclosure, may comprise: broadcasting, through a carrier wave signal, subcarriers belonging to a sensing group within a system bandwidth; receiving, from a terminal, a backscattered signal including modulated information; and detecting the modulated information in units of a predetermined symbol unit, wherein the subcarriers of the sensing group include a data-transmission subcarrier on which the modulated information is transmitted and a non-data-transmission subcarrier on which the modulated information is not transmitted, and wherein the modulated information is in units of one bit.

The detecting of the modulated information may comprise: determining the modulated information as a first value based on the backscattered signal not being received; and determining the modulated information as a second value based on the backscattered signal being received.

The detecting of the modulated information may comprise: detecting the modulated information as a first value based on a subcarrier on which data is present among subcarriers in the backscattered signal being shifted by a first frequency from the data-transmission subcarrier; and detecting the modulated information as a second value based on a subcarrier on which data is present among the subcarriers in the backscattered signal being shifted by a second frequency from the data-transmission subcarrier.

The detecting of the modulated information may comprise: detecting the modulated information as a first value based on detecting that data is present on the data-transmission subcarrier among subcarriers in the backscattered signal; and detecting the modulated information as a second value based on detecting that data is present on a subcarrier shifted by a first frequency from the data-transmission subcarrier among the subcarriers in the backscattered signal.

According to exemplary embodiments of the present disclosure, when communication and sensing share a common frequency band, an AIoT device can reliably transmit sensing-collected information to a base station (or TRP). In particular, the AIoT device can transmit the collected information to the base station (or TRP) in a reliable manner while maintaining low-complexity operation. Furthermore, the modulation method of the AIoT device can reduce interference to adjacent communication systems while supporting a suitable transmission rate, and can transmit the collected information to the base station (or TRP) without performing channel estimation or channel compensation. In addition, the exemplary embodiments of the present disclosure provide an advantage in that the AIoT device can transmit the collected information to the base station (or TRP) without being affected by hardware impairment, even when severe phase distortion occurs.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram according to a first exemplary embodiment of a terrestrial AIoT topology.

FIG. 3B is a conceptual diagram according to a second exemplary embodiment of a terrestrial AIoT topology.

FIG. 4 is a conceptual diagram according to a non-terrestrial AIoT topology.

FIG. 5 is a sequence diagram illustrating a case in which an AIoT device transmits a backscattered signal in response to a carrier wave signal from a TRP in an AIoT system.

FIG. 6A is a conceptual diagram illustrating a configuration of a system bandwidth used in a communication system according to the present disclosure.

FIG. 6B is a conceptual diagram illustrating subcarriers and subcarrier indexes that configure the respective groups in the system bandwidth illustrated in FIG. 6A.

FIG. 6C is a conceptual diagram illustrating a case in which an AIoT device transmits information to a TRP or base station by using subcarriers of an AIoT group.

FIG. 7 is a conceptual diagram illustrating a signal obtained by converting a carrier wave signal into the time domain.

FIG. 8A is a conceptual diagram illustrating a modulation output when a bit value of an information bit string that an AIoT device intends to transmit is ‘0’.

FIG. 8B is a diagram illustrating signal allocation to subcarriers of an AIoT group when a bit value of an information bit string that an AIoT device intends to transmit is ‘0’.

FIG. 8C is a conceptual diagram illustrating a modulation output when a bit value of an information bit string that an AIoT device intends to transmit is ‘1’.

FIG. 8D is a diagram illustrating signal allocation to subcarriers of an AIoT group when a bit value of an information bit string that an AIoT device intends to transmit is ‘1’.

FIG. 9A is a conceptual diagram illustrating a modulation process when a bit value of an information bit string that the AIoT device intends to transmit is ‘0’.

FIG. 9B is a conceptual diagram illustrating a modulation process when a bit value of an information bit string that an AIoT device intends to transmit is ‘1’.

FIG. 9C is a conceptual diagram illustrating subcarriers of an AIoT group received at a TRP when a bit value of an information bit string that an AIoT device transmits is ‘0’.

FIG. 9D is a conceptual diagram illustrating subcarriers of an AIoT group received at a TRP when a bit value of an information bit string that an AIoT device transmits is ‘1’.

FIG. 10 is a sequence chart illustrating a case in which a TRP and an AIoT device transmit collected information to a counterpart side.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

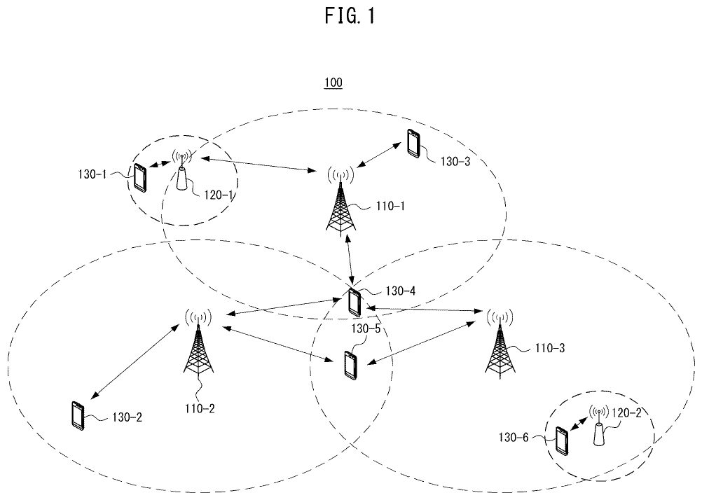

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), etc. specified in the 3rd generation partnership project (3GPP) standards. The 4G communication may be performed in frequency bands below 6 GHz, and the 5G communication may be performed in frequency bands above 6 GHz as well as frequency bands below 6 GHz.

For example, in order to perform the 4G communication and 5G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

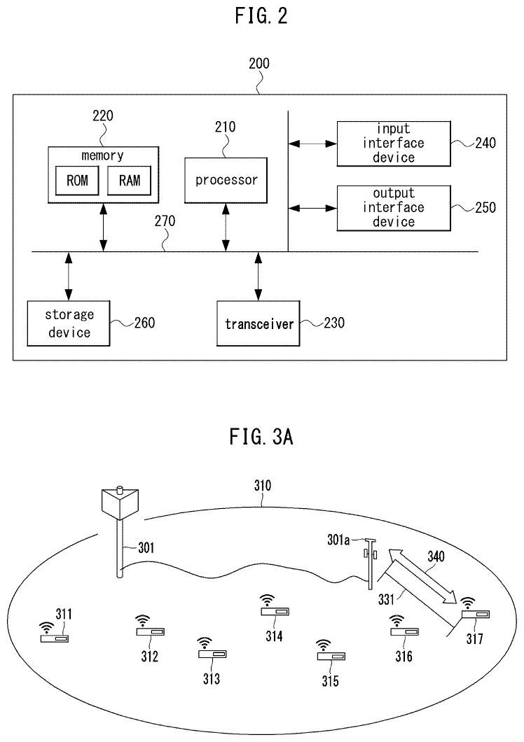

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In the present disclosure, a phrase including “when ˜” may be expressed as a phrase including “based on ˜” or a phrase including “in response to ˜”. In other words, a phrase including “when ˜” may be interpreted as being the same as or similar to a phrase including “based on ˜” or a phrase including “in response to ˜”.

In the present disclosure described below, methods and apparatuses for reducing power consumption of an IoT device are described.

As one of the wireless communication systems for reducing power consumption of a user equipment (UE) such as an IoT device, a narrow band Internet-of-Things (NB-IoT) system has been proposed. The NB-IoT system may be an OFDM-based system. A transmission node of the OFDM-based NB-IoT system may transmit information to a reception node by using one subcarrier group (PRB(s)) or two or more subcarrier groups (PRBs) among available subcarrier groups of an N-point IFFT input in the frequency domain.

The reception node may receive PRB(s) allocated to the reception node by performing analog/digital filtering only for the PRB(s) allocated to the reception node. In addition, the reception node may perform channel estimation, compensation, and/or channel decoding for the PRB(s) allocated to the reception node. The reception node may restore information transmitted to the reception node from the allocated PRB(s) through these procedures. In other words, when the reception node of the NB-IoT system is a UE, the UE needs to perform channel estimation, channel compensation, and channel decoding in order to restore the PRB(s) allocated to the UE.

Meanwhile, when an IoT system is constructed, if batteries of IoT devices need to be replaced or the batteries of IoT devices need to be charged, it is almost impossible for a manager to replace the batteries of the IoT devices or to charge the batteries of the IoT device every time. When the manager should replace or charge batteries of all IoT devices, high maintenance cost and serious environmental problems may occur.

As a method for solving the above-described problems, a battery-less IoT device may be considered. The battery-less IoT device refers to a device that uses harvested ambient energy as its power source by harvesting energy from a radio wave, light, motion, heat, or another suitable power source obtainable around the IoT device. A barcode and a radio frequency identification (RFID) tag used in most industries at present may be ultra-small battery-less IoT devices having low cost and low complexity.

However, the RFID tag has a limited reading range of several meters and requires an operator to perform manual scanning. In other words, since the RFID tag requires manpower for performing manual scanning, the RFID tag is labor-intensive. In addition, when the operator manually scans all RFID tags, a long time is required.

As the above-described problems have been raised, since 2024, the 3rd Generation Partnership Project (3GPP) Rel-19 standardization has been conducting a study item (SI) named ambient Internet-of-Things (AIoT). The AIoT scheme discussed in the Rel-19 standardization is intended to have a wide reading range of 10 meters to 50 meters. In addition, the AIoT scheme discussed in the Rel-19 standardization allows a mobile communication system to automatically manage a plurality of (e.g. two or more to hundreds of) battery-less IoT devices.

In addition, the AIoT scheme defines ultra-low power, ultra-low cost, and low complexity as requirements of the AIoT device. As a method for satisfying ultra-low power of the AIoT device in the AIoT scheme, battery-less AIoT devices are also discussed. Based on the requirements of the AIoT scheme, since the reception node of the NB-IoT system needs to perform channel estimation, channel compensation, and channel decoding, the ultra-low-power requirement cannot be satisfied. In other words, in the AIoT scheme, AIoT devices need to be configured not to perform channel estimation, channel compensation, and channel decoding operations.

Meanwhile, automation and digitalization have recently progressed in various industrial fields. Due to automation and digitalization in various industrial fields, introduction of IoT technology is required not only in industrial fields in which IoT technology is applied (provided) at present but also in new markets (industrial fields). Particularly, in new industrial fields, a requirement for a battery-less IoT device (e.g. AIoT device) that does not need to manually replace a battery of the IoT device or to charge the IoT device and does not include an energy-storage function is increasing further.

In the present disclosure described below, an AIoT scheme is described. The AIoT scheme may be included in an IoT scheme in a broad sense. Therefore, the AIoT scheme described below may be understood as the IoT scheme. In addition, it should be noted that an AIoT device described below can be understood as an IoT device.

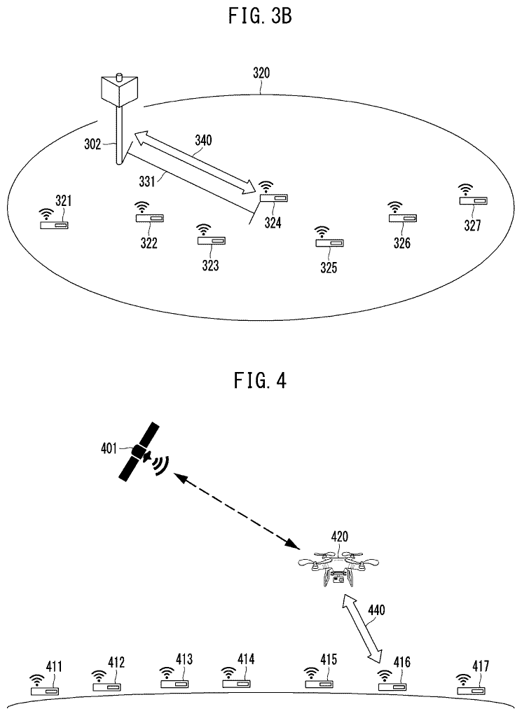

FIG. 3A is a conceptual diagram according to a first exemplary embodiment of a terrestrial AIoT topology, and FIG. 3B is a conceptual diagram according to a second exemplary embodiment of a terrestrial AIoT topology.

Referring to FIG. 3A, a plurality of AIoT devices 311, 312, 313, 314, 315, 316, and 317 may exist at various positions within a communication area 310 of a base station 301. In addition, the base station 301 may be connected to an intermediate node 301a through a predetermined connection scheme. The exemplary embodiment of FIG. 3A may correspond to a case in which the base station 301 and the intermediate node 301a are connected by a wired connection. However, the base station 301 and the intermediate node 301a may be connected based on a mobile communication scheme or another wireless communication scheme. The intermediate node 301a may transmit AIoT data or a sensing signal to an AIoT device 317 located within a preset distance 331. Here, the preset distance 331 may be a distance within maximum 50 meters as described above. Transmission and reception of the AIoT data and/or the sensing signal between the intermediate node 301a and the AIoT device 317 are illustrated by reference numeral 340.

The AIoT topology illustrated in FIG. 3A may correspond to a case in which the base station 301 has the intermediate node 301a connected to the base station 301. As illustrated in FIG. 3A, through the AIoT topology having the intermediate node 301a, the base station 301 may perform indirect communication (e.g. transmission and/or reception of AIoT data) and sensing with the AIoT device 317 located in an indoor environment such as a home, an office, or a factory.

The AIoT topology illustrated in FIG. 3A may also correspond to a case in which the intermediate node 301a is additionally installed for communication and sensing with AIoT devices located at a long distance from the base station 301, even in an outdoor environment, because communication and sensing ranges of the AIoT devices 311 to 317 are narrow.

Referring to FIG. 3B, a plurality of AIoT devices 321, 322, 323, 324, 325, 326, and 327 are illustrated as being present at various positions within a communication area 320 of a base station 302. The AIoT topology of FIG. 3B may correspond to a case in which the base station 302 directly transmits AIoT data or a sensing signal to the AIoT device 324. In other words, the AIoT topology illustrated in FIG. 3B may correspond to a case in which direct communication and sensing are performed by the base station 302 in an indoor environment.

The AIoT topology illustrated in FIG. 3B may also be in an outdoor environment. The AIoT data and/or the sensing signal transmitted and received between the base station 302 and the AIoT device 324 are illustrated by the same reference numeral 340 as in FIG. 3A.

FIG. 4 is a conceptual diagram according to a non-terrestrial AIoT topology.

Referring to FIG. 4, a plurality of AIoT devices 411, 412, 413, 414, 415, 416, and 417 are illustrated as being present at various positions on the ground. In addition, a satellite 401 may perform communication (e.g. transmission and reception of AIoT data) and sensing 440 with the AIoT device 416 on the ground through an intermediate node 420 located at a certain distance (e.g. within 50 meters from the AIoT device) close to the ground.

At present, 3GPP discusses only the terrestrial AIoT topology, but it is expected to be extended to the non-terrestrial AIoT topology illustrated in FIG. 4 in the future.

The AIoT device discussed in 3GPP may be a device having battery-less, low-cost, and/or low-complexity characteristics. Therefore, when hardware impairment of the AIoT device occurs, phase distortion due to hardware impairment may be severe.

However, in the AIoT scheme, a complex radio transmission scheme for compensating for phase distortion due to hardware impairment needs to be excluded. In addition, when the AIoT device transmits IoT collected information to the base station in the AIoT scheme, power consumption according to a transmission time needs to be minimized. Furthermore, a transmission rate of the AIoT device needs to be guaranteed as a rate that can minimize interference to another base station or another AIoT device and/or interference toward another AIoT device.

However, in current AIoT technology, methods and apparatuses capable of satisfying these requirements have not been presented. Therefore, in the present disclosure described below, methods and apparatuses capable of communicating without channel estimation and compensation even when phase distortion occurs in the AIoT scheme are provided.

In the present disclosure, a wireless device is referred to as a mobile station (MS). The MS may be a terminal or user equipment (UE).

In the present disclosure, a device that transmits a signal to a MS or receives a signal of a MS is referred to as a transmission and reception point (TRP). A device that supervises TRP(s) is referred to as a base station (BS), and an area (or communication coverage) supervised by the BS is referred to as a cell.

In addition, a terminal according to the AIoT scheme used in the present disclosure is referred to as an AIoT device. The AIoT scheme described in the present disclosure may also be understood as an IoT scheme, and the AIoT device may be understood in various forms such as an IoT device, IoT terminal, AIoT terminal, UE, MS, mobile terminal (MT), IoT MS, and IoT MT.

### First Exemplary Embodiment

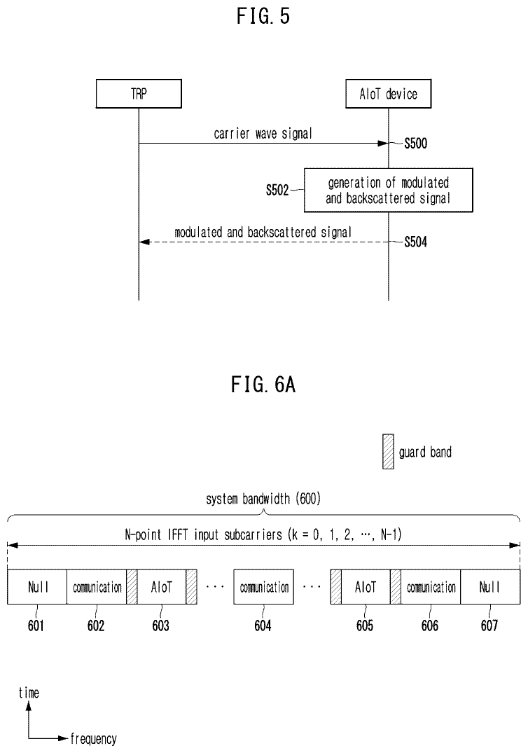

FIG. 5 is a sequence diagram illustrating a case in which an AIoT device transmits a backscattered signal in response to a carrier wave signal from a TRP in an AIoT system.

FIG. 5 illustrates a procedure for transmitting and receiving signals of a TRP and an AIoT device. Before describing an operation according to FIG. 5, a configuration of the TRP and the AIoT device illustrated in FIG. 5 is described first.

Each of the TRP and the AIoT device illustrated in FIG. 5 may correspond to the communication node described in FIG. 2. Therefore, the TRP and the AIoT device may be configured in a form that includes at least some of the components in FIG. 2.

For example, the TRP may be controlled by a base station and may be a transmission and reception device arranged at a location spaced apart from the base station within a cell of the base station. The TRP may include all or at least some of the components of FIG. 2. The configuration illustrated in FIG. 2 may be a configuration for the TRP to communicate with a MS.

The TRP may support communication according to the AIoT scheme according to the present disclosure. The TRP may be an intermediate node based on the AIoT topology described in FIG. 3A. In order for the TRP to operate as an intermediate node based on the AIoT topology, the TRP may further include an AIoT signal transmission device for transmitting a signal to an AIoT device and an AIoT signal reception device for receiving a backscattered signal from the AIoT device. In other words, the TRP may further include the AIoT signal transmission device for transmitting a carrier wave signal to the AIoT device and the AIoT signal reception device for receiving a backscattered signal from the AIoT device.

As described above, the AIoT device needs to have low complexity. Therefore, the AIoT device may be configured only with the processor 210, the transceiver 230, and the memory 220 among the components of FIG. 2. The transceiver 230 may include a reception device for receiving a carrier wave signal, a modulation device for modulating the received signal, and a backscattering device for performing backscattering. The AIoT device may be a battery-less device. Therefore, the AIoT device may further include a power storage apparatus for harvesting and storing power.

The procedure of FIG. 5 is described based on the configuration of the TRP and the AIoT device described above.

In step S500, the TRP may transmit a carrier wave signal including information or a sensing signal to the AIoT device by using subcarriers allocated to an AIoT group (or IoT group) among subcarriers within a system bandwidth.

In step S500, the AIoT device may receive the carrier wave signal. Since the AIoT device is a battery-less device, the AIoT device may harvest energy from the carrier wave signal received from the TRP. The AIoT device may perform step S502 when harvested energy is sufficient to transmit a signal and data to be transmitted to the TRP exists. When energy harvested from the carrier wave signal received from the TRP is insufficient or data to be transmitted to the TRP does not exist, the AIoT device may not perform step S502.

For example, when energy harvested from the carrier wave signal received from the TRP is insufficient, the AIoT device may additionally harvest and store energy from the carrier wave received from the TRP. On the other hand, even when energy harvested from the carrier wave signal received from the TRP is sufficient, but data to be transmitted to the TRP does not exist, the AIoT device may not perform step S502.

The data to be transmitted from the AIoT device to the TRP may be data collected by the AIoT device (or acquired by using a sensor of the AIoT device). The AIoT device may collect only data for a specific purpose. The specific purpose may be an installation purpose of the AIoT device and may vary for each industrial field. For example, when the AIoT device performs counting of manufactured products in a factory automation system, a value obtained by counting the manufactured products may be the collected data. In another example, when the AIoT device is a device for sensing temperature variation inside a specific factory, the collected data may be an amount of temperature variation or a current temperature value. In another example, when the AIoT device is a device for measuring pressure of facilities inside a factory, the collected data collected by the AIoT device may be pressure information. The data collected by the AIoT device may have various forms in various industrial fields as described above.

In step S502, the AIoT device may modulate the collected information to transmit the collected information using the received carrier wave signal. The AIoT device may generate a backscattered signal by applying the modulated signal to the carrier wave signal.

Since the AIoT device needs to have low complexity, it is not preferable to configure the AIoT device to use a complex modulation scheme. Therefore, in the first exemplary embodiment, a case is assumed in which an on-off keying (OOK) modulation scheme is used for the AIoT device. For example, the AIoT device may cause the received carrier wave signal to be backscattered or cause the received carrier wave signal not to be backscattered according to a data value to be transmitted. This is described in more detail below.

The information collected by the AIoT device may be information to be transmitted to the TRP. The information collected by the AIoT device may be configured as a bit string. Each bit of the bit string may have a value of ‘0’ or ‘1’.

When a bit value to be transmitted is ‘0’, the AIoT device may cause the received carrier wave signal not to be backscattered. In contrast, when a bit value to be transmitted is ‘1’, the AIoT device may cause the received carrier wave signal to be backscattered. In other words, when a bit value of the bit string to be transmitted to the TRP is ‘0’, the AIoT device may control the transceiver not to perform backscattering. In contrast, when a bit value of the bit string to be transmitted to the TRP is ‘1’, the AIoT device may control the transceiver to perform backscattering. As described above, according to whether backscattering is performed, the AIoT device may transmit or may not transmit a signal to the TRP.

In step S504, the AIoT device may transmit the modulated and backscattered signal to the TRP based on the method described above. In step S504, the TRP may receive the backscattered signal from the AIoT device. The TRP may identify whether a bit value is ‘0’ or ‘1’ according to whether a signal from the AIoT device is received.

In the first exemplary embodiment described above, the AIoT device may backscatter or may not backscatter bit information to be transmitted according to on/off of backscattering in units of a symbol time length defined by the TRP. However, when the AIoT device performs on-off 180-degree phase switching (OOPS) modulation and backscattering, its operation may be performed as follows. For example, when a bit value to be transmitted in a symbol duration defined by the TRP is ‘0’, the AIoT device may disable backscattering or may perform backscattering as in the first exemplary embodiment. When the bit value is ‘1’, the AIoT device may perform backscattering without phase inversion during a first half of a specific shift frequency fₘ, and may perform backscattering with a 180-degree phase inversion during a remaining half of the specific shift frequency fₘ, which is different from the first exemplary embodiment.

As described above, the carrier wave signal may be backscattered or may not be backscattered by the AIoT device according to the bit value to be transmitted. In FIG. 5, step S504 is indicated by a dotted line in order to express this.

In the present disclosure, a phase distortion may occur in a signal backscattered by the AIoT device to the TRP according to characteristics of the AIoT device, and a transmission timing error may occur based on a distance between the AIoT device and the TRP. However, in the first exemplary embodiment of the present disclosure, a case in which the phase distortion and the transmission timing error do not exist is assumed. However, the first exemplary embodiment of the present disclosure may also be applied to a case in which a signal backscattered by the AIoT device to the TRP includes the phase distortion and the transmission timing error.

In step S504, the TRP may receive the signal backscattered from the AIoT device. When the backscattered signal is not received, the TRP may determine that the AIoT device transmitted a bit value ‘0’, and when the backscattered signal is received, the TRP may determine that the AIoT device transmitted a bit value ‘1’.

Resources allocated to the TRP and the AIoT device according to the present disclosure are described below.

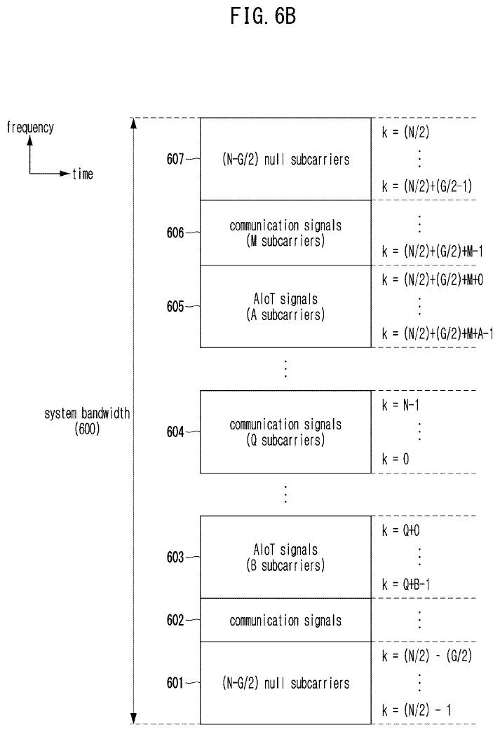

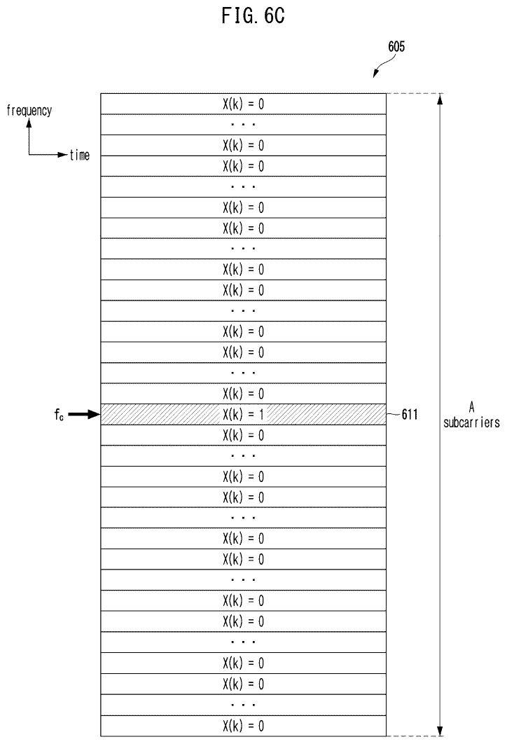

FIG. 6A is a conceptual diagram illustrating a configuration of a system bandwidth used in a communication system according to the present disclosure.

Referring to FIG. 6A, a system bandwidth 600 may be divided into a plurality of groups. The system bandwidth 600 illustrated in FIG. 6A may refer to an entire system bandwidth that a base station and/or a TRP may allocate in a network in which the AIoT scheme and communication are used together.

The system bandwidth 600 illustrated in FIG. 6A may be configured with a plurality of subcarriers. The system bandwidth 600 may be divided into a plurality of groups each configured with one or more subcarriers. As illustrated in FIG. 6A, from the lowest subcarrier to the highest subcarrier, the configuration may include a null group 601 including one or more subcarriers, a communication group 602 including one or more subcarriers, an AIoT group 603 including one or more subcarriers, a communication group 604 including one or more subcarriers, an AIoT group 605 including one or more subcarriers, a communication group 606 including one or more subcarriers, and a null group 607 including one or more subcarriers.

In the exemplary embodiment of FIG. 6A, a case in which the system bandwidth 600 is configured with a plurality of communication groups 602, 604, and 606 and a plurality of AIoT groups 603 and 605 is illustrated. A detailed configuration of the system bandwidth 600 illustrated in FIG. 6A is for helping understanding of the present disclosure, and the system bandwidth 600 should not be construed as being limited to the same form as illustrated in FIG. 6A.

As illustrated in FIG. 6A, the null group 601 may correspond to a subcarrier group having the lowest frequency of the system bandwidth 600, and the null group 607 may correspond to a subcarrier group having the highest frequency of the system bandwidth 600. Each of the null groups 601 and 607 may be used to prevent out-of-band (OOB) radiation. The null groups 601 and 607 may use a predetermined number of subcarriers (null group subcarriers) from the lowest-frequency subcarrier and a predetermined number of subcarriers (null group subcarriers) from the highest-frequency subcarrier, respectively, in order to prevent OOB radiation from occurring toward subcarriers outside the system bandwidth 600. The subcarriers included in the null groups 601 and 607 may prevent OOB radiation by not transmitting any signal. In other words, all subcarriers included in each of the null groups 601 and 607 may be subcarriers configured as a guard band (GB) where no signal is transmitted.

The remaining subcarriers excluding the null groups 601 and 607 disposed at both edges of the system bandwidth 600 may be configured as the communication groups 602, 604, and 606 and the AIoT groups 603 and 605. As needed, only one AIoT group may be configured, unlike the example illustrated in FIG. 6A. In another example, three or more AIoT groups may be configured. In each of the two AIoT groups 603 and 605 illustrated in FIG. 6A, some subcarriers adjacent to a communication group may be used as a GB.

All subcarriers of the system bandwidth 600 may be used as an input of N-point IFFT in a transmission device of the OFDM system. When the number of total subcarriers is N, a subcarrier index k allocated to each of subcarriers may be given as 0, 1, 2, . . . , or N-1. The subcarrier indexes may be allocated in order from the lowest subcarrier to the highest subcarrier, may be allocated in order from the highest subcarrier to the lowest subcarrier, or may be allocated based on an arbitrary subcarrier.

As illustrated in FIG. 6A, a method of classifying the subcarriers excluding the null groups 601 and 607 in the system bandwidth 600 into two or more groups each including one or more subcarriers may be understood as a method of multiplexing and using resources of the system bandwidth 600. A resource multiplexing type according to the present disclosure should not be understood as being limited to the type illustrated in FIG. 6A, and various types of resource multiplexing methods may exist.

FIG. 6B is a conceptual diagram illustrating subcarriers and subcarrier indexes that configure the respective groups in the system bandwidth illustrated in FIG. 6A.

Referring to FIG. 6B, a predetermined number of subcarriers in ascending order from a subcarrier having the lowest frequency may be included in the null group 601, and a predetermined number of subcarriers in descending order from a subcarrier having the highest frequency may be included in the null group 607. For convenience of description, the null group 601 configured with a predetermined number of subcarriers from the lowest frequency upward is referred to as a first null group, and the null group 607 configured with a predetermined number of subcarriers from the highest frequency downward is referred to as a second null group.

A case is assumed in which the number of subcarriers included in the first null group 601 is the same as the number of subcarriers included in the second null group 607, and G subcarriers determined as a multiple of 2 are allocated to the first null group 601 and the second null group 607. In this case, G/2 subcarriers may be allocated to the first null group 601, and G/2 subcarriers may be allocated to the second null group 607

The communication group 602 adjacent to the first null group 601 is referred to as a first communication group, the communication group 604 illustrated next is referred to as a second communication group, and the communication group 606 adjacent to the second null group 607 is referred to as a third communication group. In addition, the AIoT group 603 adjacent to the first communication group 602 is referred to as a first AIoT group, and the AIoT group 605 adjacent to the third communication group 606 is referred to as a second AIoT group.

According to the example of FIG. 6B, the second communication group 604 may be configured with Q subcarriers, and the third communication group 606 may be configured with M subcarriers. In addition, the first AIoT group 603 may be configured with B subcarriers, and the second AIoT group 605 may be configured with A subcarriers.

In FIG. 6B, a case is assumed in which the subcarrier index k of the lowest subcarrier included in the second communication group 604 is set to 0. FIG. 6B illustrates, based on subcarrier index 0, the subcarrier index ranges (k values) of each of the groups 601 to 607, including the lowest-frequency subcarrier and the highest-frequency subcarrier in each group.

For example, in the first null group 601, a subcarrier index of the lowest subcarrier may be (N/2)−1, and a subcarrier index of the highest subcarrier may be (N/2)−(G/2). In the first AIoT group 603, a subcarrier index of the lowest subcarrier may be Q+B−1, and a subcarrier index of the highest subcarrier may be Q+0. In addition, in the second communication group 604, a subcarrier index of the lowest subcarrier may be 0, and a subcarrier index of the highest subcarrier may be N-1. In the same manner, in the second AIoT group 605, a subcarrier index of the lowest subcarrier may be (N/2)+ (G/2)+M+A−1, and a subcarrier index of the highest subcarrier may be (N/2)+(G/2)+M+0. The remaining third communication group 606 and second null group 607 may also have subcarrier indexes determined in the same manner.

The system bandwidth 600 configured with N subcarriers as illustrated in FIGS. 6A and 6B may be an entire bandwidth that one base station and/or one TRP may use.

Based on the configuration of FIGS. 6A and 6B, in step S500 described in FIG. 5, the TRP may transmit the carrier wave signal to the AIoT device by using subcarriers of the first AIoT group 603 or subcarriers of the second AIoT group 605. Therefore, in step S500, the AIoT device may receive the carrier wave signal configured with the subcarriers of the first AIoT group 603 or the subcarriers of the second AIoT group 605.

In the present disclosure described below, a case is described in which communication between the TRP and the AIoT device is performed by using the second AIoT group 605. However, this is merely one example, and the first AIoT group 603 may also be used. When the respective groups in the system bandwidth 600 are configured in a form different from FIG. 6A, communication between the TRP and the AIoT device in a specific AIoT group may be performed based on a method described below.

FIG. 6C is a conceptual diagram illustrating a case in which an AIoT device transmits information to a TRP or base station by using subcarriers of an AIoT group.

Referring to FIG. 6C, the second AIoT group 605 may be configured with A subcarriers. The AIoT device may transmit a carrier wave signal by using A subcarriers included in the second AIoT group 605, and the AIoT device may enable data to be transmitted through only one subcarrier using the backscattered signal, and may prevent data from being transmitted on the remaining subcarriers. In FIG. 6C, such a configuration may mean that data is transmitted only on a subcarrier illustrated as a central frequency fc, and remaining subcarriers may be subcarriers on which data is not transmitted. In the present disclosure, the subcarrier on which the carrier wave signal is transmitted is referred to as a ‘carrier-transmission subcarrier’, and a subcarrier on which the carrier wave signal is not transmitted is referred to as a ‘non-carrier-transmission subcarrier’.

Subcarriers indicated as “X(k)=0” in FIG. 6C may all indicate non-data-transmission subcarriers on which data is not transmitted, and a subcarrier 611 indicated as “X(k)=1” may indicate a data-transmission subcarrier on which data is transmitted. In other words, in the second AIoT group 605, data may be transmitted only on the data-transmission subcarrier 611 indicated as “X(k)=1”, and data may not be transmitted on the remaining non-data-transmission subcarriers indicated as “X(k)=0”.

The data transmission method illustrated in FIG. 6C is merely one example, and two or more data-transmission subcarriers may exist in one AIoT group. For example, in the second AIoT group 605, bit(s) of an information bit string may be transmitted through two subcarriers that are not adjacent to each other, or bit(s) of the information bit string may be transmitted through three or more subcarriers that are not adjacent to each other.

Subcarriers of the second AIoT group 605 that transmit bits of the information bit string through one or two or more subcarriers may be transmitted while being loaded on the carrier wave signal. In other words, in one AIoT group, data-transmission subcarrier(s) may be one subcarrier or may be two or more subcarriers.

In FIG. 6C, “X(k)=1” is indicated inside the data-transmission subcarrier 611 to indicate that it corresponds to the subcarrier on which bit(s) of the information bit string are transmitted. The expression “X(k)=1” in FIG. 6C may mean that desired transmission power is applied to the corresponding subcarrier in an environment in which transmission is actually performed in radio frequency (RF). Furthermore, when the position of the subcarrier within the AIoT group reflected in the carrier wave signal in FIG. 6C is converted into the actual frequency used for RF transmission, it may correspond to fc.

The expression “X(k)=0” in FIG. 6C may also mean that there is no transmission power on the corresponding subcarrier in an environment in which transmission is actually performed in RF.

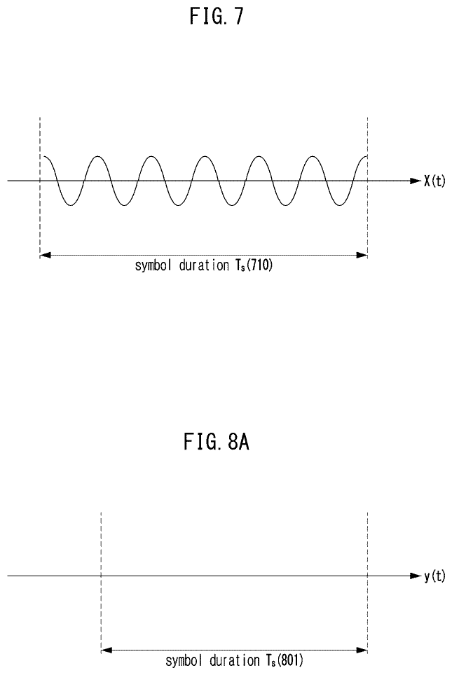

Hereinafter, a carrier wave signal transmitted on subcarrier(s) is described with reference to FIG. 7.

FIG. 7 is a conceptual diagram illustrating a signal obtained by converting a carrier wave signal into the time domain.

A carrier wave signal may refer to a signal transmitted from the TRP to the AIoT device. A time-domain converted signal x(t) of the carrier wave signal may be a cosine wave signal at a frequency fc. In other words, the time-domain converted signal x(t) of the carrier wave signal illustrated in FIG. 7 may be expressed as Equation 1 below.

$$x ( t ) = cos ( 2 π {f}_{c} t ) \qquad [ Equation 1 ]$$

Although a case in which the time-domain signal of the carrier wave signal is a cosine wave is illustrated in the exemplary embodiment of FIG. 7, this is provided merely for facilitating an understanding of the present disclosure and is not intended to limit the present disclosure. In other words, the time-domain signal of the carrier wave signal may be a sine wave. In addition, when a carrier wave signal configured as a sine wave or a cosine wave is transmitted as an RF signal, a random or constant phase component may exist in the RF signal. Further, when a carrier wave signal configured as a sine wave or a cosine wave is transmitted through actual RF, a desired amount of transmission power may be applied.

A symbol duration Tₛ illustrated in FIG. 7 may indicate an effective OFDM symbol time or an OFDM symbol time in an OFDM transmission mode, and may correspond to a single carrier (SC) symbol time in an SC transmission mode. In the exemplary embodiment of the present disclosure, the cosine wave signal of the symbol, such as in FIG. 7, may be continuously transmitted across consecutive symbols.

Therefore, in step S504 illustrated in FIG. 5, a time unit in which the AIoT device performs backscattering or does not perform backscattering may correspond to a symbol duration unit (i.e. OFDM transmission mode) or an SC symbol time (i.e. SC transmission mode) in which one bit of information is maintained.

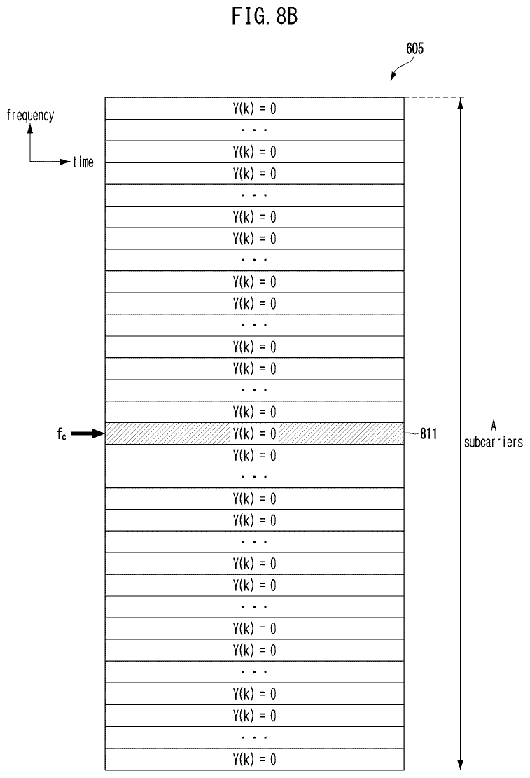

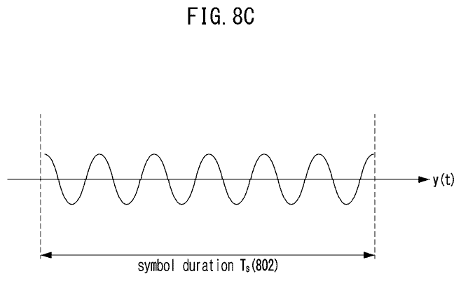

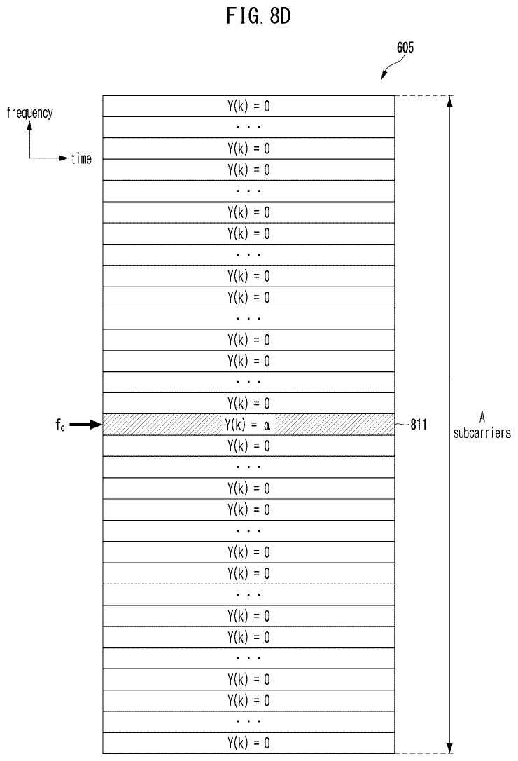

In step S504 described above, one information bit may be determined according to the symbol duration based on a signal backscattered by the AIoT device. A time-domain signal shape when ‘0’ is transmitted in the symbol duration and a time-domain signal shape when ‘1’ is transmitted in the symbol duration are further described below by using FIGS. 8A and 8C.

FIG. 8A is a conceptual diagram illustrating a modulation output when a bit value of an information bit string that an AIoT device intends to transmit is ‘0’.

Referring to FIG. 8A, as described above, when a bit value of the information bit string that the AIoT device intends to transmit is ‘0’, the AIoT device may cause no signal to be backscattered. Since the AIoT device causes no signal to be backscattered, a backscattered signal y(t) received at a TRP, after experiencing a path loss and fading in an actual channel and having noise added, may output a value of 0 in a symbol duration Tₛ 801 as illustrated in FIG. 8A.

FIG. 8B is a diagram illustrating signal allocation to subcarriers of an AIoT group when a bit value of an information bit string that an AIoT device intends to transmit is ‘0’.

FIG. 8B illustrates signals of subcarriers received at the TRP. As described above, the AIoT device may configure zero values to all subcarriers within the second AIoT group 605 composed of A subcarriers. The AIoT device may modulate each bit of the information bit string to be transmitted through the OOK modulation scheme. In addition, as described above with reference to FIG. 6C, the AIoT device may transmit desired information by applying the information to a centrally located subcarrier.

When a bit value ‘0’ of the information bit string that the AIoT device intends to transmit is backscattered, the TRP may receive ‘0’ on all subcarriers belonging to the second AIoT group 605 as illustrated in FIG. 8B. Further, the TRP may confirm that the bit transmitted through the centrally located subcarrier 811 on which the AIoT device transmits information is ‘0’. Therefore, the TRP may confirm that ‘0’ has been received from the AIoT device.

When a bit value of the information bit string is ‘1’, the AIoT device may modulate the received time-domain signal such that the time-domain signal illustrated in FIG. 7 is backscattered as is. In other words, when a bit value of the information bit string is ‘1’, the AIoT device may perform OOK(1) modulation. In this case, a frequency-domain signal shape backscattered toward the TRP and a time-domain signal shape corresponding thereto are further described by using FIGS. 8B and 8D.

FIG. 8C is a conceptual diagram illustrating a modulation output when a bit value of an information bit string that an AIoT device intends to transmit is ‘1’.

Referring to FIG. 8C, as described above, when a bit value of the information bit string that the AIoT device intends to transmit is ‘1’, the AIoT device may modulate such that the received carrier wave signal is backscattered as is in the symbol duration Tₛ 802 as illustrated in FIG. 7. The signal backscattered by the AIoT device may experience path loss and fading in an actual channel and may be transmitted with noise added. A backscattered signal y(t) received by the TRP may be a signal identical to the carrier wave signal as in the symbol duration Tₛ 802 illustrated in FIG. 8B.

Meanwhile, the AIoT device may transmit the bit value ‘1’ by OOK modulation on the centrally located subcarrier, which is a subcarrier in the second AIoT group 605 on which information is transmitted. This is described with reference to FIG. 8D.

FIG. 8D is a diagram illustrating signal allocation to subcarriers of an AIoT group when a bit value of an information bit string that an AIoT device intends to transmit is ‘1’.

FIG. 8D illustrates signals of subcarriers received at the TRP. As described above, the AIoT device may configure zero values to all subcarriers within the second AIoT group 605 composed of A subcarriers. The AIoT device may modulate each bit of the information bit string to be transmitted through the OOK modulation scheme. In addition, as described above with reference to FIG. 6C, the AIoT device may transmit desired information by applying the information to a centrally located subcarrier.

When a bit value ‘1’ of the information bit string that the AIoT device intends to transmit is backscattered, the TRP may, as illustrated in FIG. 8D, detect an OOK(1) value modulated based on the OOK modulation scheme through the centrally located subcarrier 811 among all subcarriers belonging to the second AIoT group 605. In this case, all subcarriers other than the centrally located subcarrier 811 among all subcarriers belonging to the second AIoT group 605 may be transmitted by being set to ‘0’.

The TRP may acquire Y(k) value through the backscattered signal received from the AIoT device. A case where Y(k) is a is illustrated in FIG. 8D. The value “Y(k)-a” received through the centrally located subcarrier 811 illustrated in FIG. 8D may be a value expressed based on the following assumptions for convenience of description. First, fading is assumed to be 1. Second, a case where no noise is added is assumed. Third, a case where the backscattered signal has only path loss is assumed. Under these assumptions, the value Y(k) received through the subcarrier 811 in the backscattered signal received at the TRP may represent that a strength of the received signal is a.

In the present disclosure, the backscattered signal received at the TRP is described as an example based on the assumptions described above. However, the exemplary embodiments of the present disclosure may identify data transmitted by the AIoT device from the backscattered signal received at the TRP in the same manner even when the assumptions are not applied, in other words, when fading and noise exist.

Meanwhile, in addition to the backscattered signal received from the AIoT device, a signal reflected on a surface of the AIoT device and entering the TRP may exist. When a signal reflected on the surface of the AIoT device and entering the TRP exists, the TRP may have difficulty in accurately detecting OOK(0). This is because, in a case of OOK(0), the AIoT device causes no signal to be backscattered, but in an actual environment, a reflected signal may be received at the TRP due to reflection on the surface of the AIoT device. Therefore, the TRP may have difficulty in determining whether a received signal based on a reflected signal corresponds to OOK(0). Because this is a natural phenomenon caused by an electromagnetic-wave reflection characteristic of the AIoT device, no fundamental solution exists.

The first exemplary embodiment of the present disclosure, in which the AIoT device performs backscattering or does not perform backscattering according to a bit value of an information bit string to be transmitted by using the OOK modulation scheme, has an advantage in that the AIoT device can be configured in the simplest manner, but a signal may be highly introduced into a subcarrier at a frequency fc in which no signal should exist due to a reflection problem. If a signal is highly introduced into a subcarrier at the frequency fc in which no signal should exist due to a reflection problem, the TRP may have difficulty in accurately identifying OOK0.

In the following exemplary embodiments, methods for solving problems that occur when the OOK modulation scheme according to the first exemplary embodiment is used are described.

### Second Exemplary Embodiment

In the second exemplary embodiment of the present disclosure, a one-bit on-off 180-degree phase switching (OOPS) modulation scheme may be used by modifying the OOK modulation scheme. Then, a case where the OOPS modulation scheme is used is described with reference to FIG. 5, based on the operations illustrated in FIGS. 6A to 6C and FIG. 7 for the TRP and the AIoT device.

In step S500, the TRP may transmit subcarriers of the second AIoT group 605 to the AIoT device through a carrier wave signal illustrated in FIG. 7 as described in FIGS. 6A to 6C. The carrier wave signal may be expressed as a cosine function as illustrated in Equation 1.

In step S500, the AIoT device may receive the carrier wave signal. In other words, the AIoT device may receive a time-domain signal such as that illustrated in FIG. 7. In this case, a case is assumed where data to be transmitted to the TRP exists and sufficient energy for transmission to the TRP has been accumulated through energy harvesting.

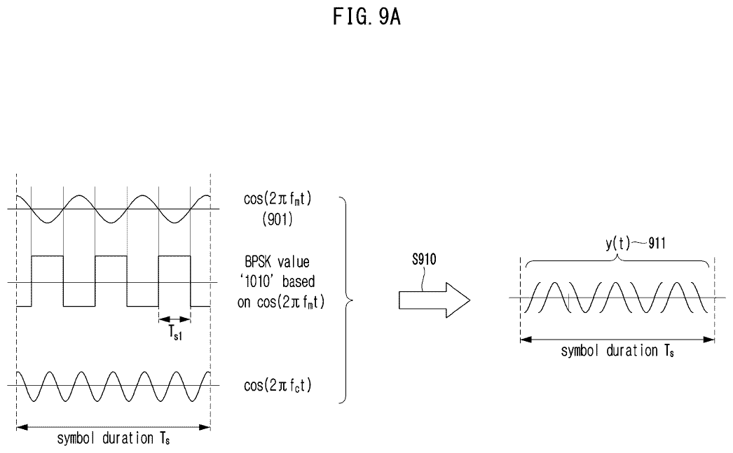

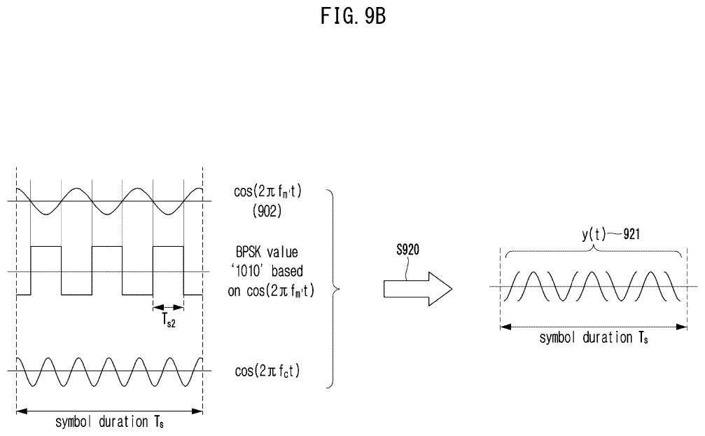

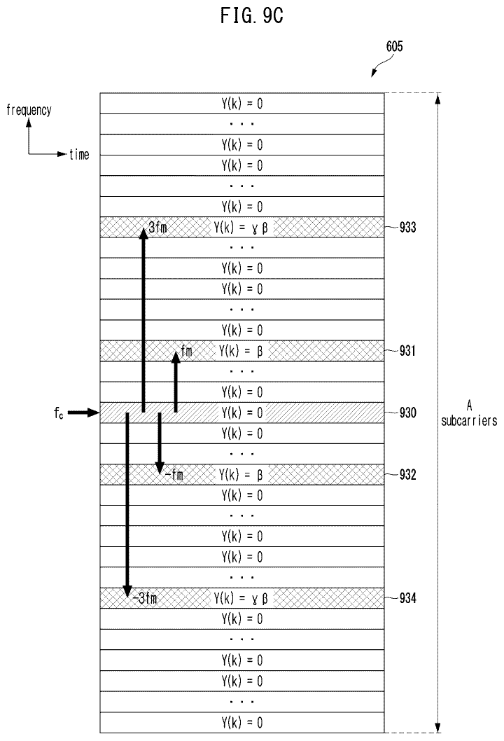

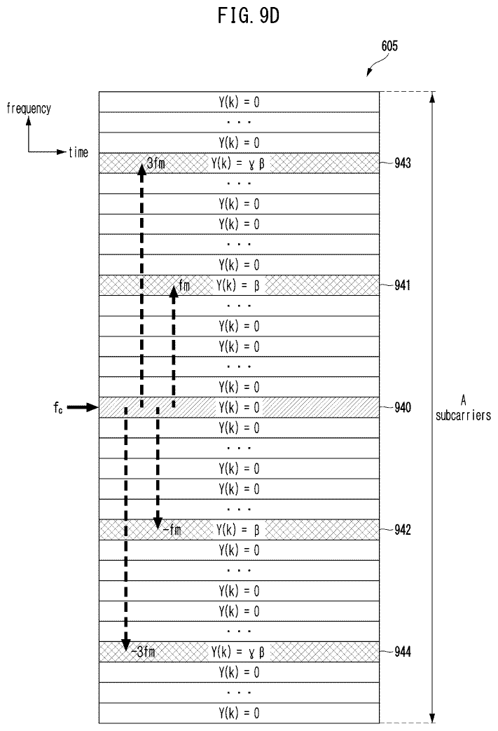

In step S502, the AIoT device may modulate information (or data) to be transmitted to the TRP by applying the one-bit OOPS modulation scheme for each symbol duration illustrated in FIG. 7. The AIoT device may perform OOPS modulation on the information bit string to be transmitted to the TRP on a per-bit basis. The OOPS modulation scheme may refer to a scheme in which a time-domain carrier wave signal, such as that illustrated in FIG. 7, is received and information to be transmitted is frequency-shifted by a predetermined frequency value. The OOPS modulation scheme is further described below with reference to FIGS. 9A and 9B.

In addition, in step S502, the AIoT device may backscatter the received carrier wave signal by applying the OOPS-modulated information.

In step S504, the AIoT device may transmit the modulated and backscattered signal to the TRP. Therefore, in step S504, the TRP may receive the modulated and backscattered signal from the AIoT device.

Hereinafter, the OOPS modulation scheme is described. When the AIoT device modulates the bit string using the OOPS scheme, the AIoT device may modulate each bit value by the OOPS scheme. In other words, the AIoT device may perform the OOPS modulation on each bit of the bit string. As described in the OOK scheme above, the OOPS modulation may refer to modulation in which a different modulated value is applied depending on each bit value of the information bit string. An operation in which OOPS modulation is performed according to a bit value of the information bit string by the AIoT device is described with reference to FIGS. 9A and 9B.

FIG. 9A is a conceptual diagram illustrating a modulation process when a bit value of an information bit string that the AIoT device intends to transmit is ‘0’.

When a bit value of an information bit string to be transmitted to the TRP is ‘0’, the AIoT device may allocate a value (or symbol) for information ‘0’ to a data-transmission subcarrier among subcarriers in the second AIoT group 605. The AIoT device may frequency-shift the data-transmission subcarrier by a first frequency shift value fₘ. This is further described in FIG. 9C described below.

In addition, the AIoT device may generate a cosine waveform 901 having the first frequency shift value fₘ corresponding to the bit value ‘0’ of the information bit string. As illustrated in FIG. 9A, the cosine waveform 901 having the first frequency shift value fₘ may be expressed as cos (2πtfₘt). The cosine waveform 901 having the first frequency shift value fₘ may be BPSK-modulated. As illustrated in FIG. 9A, the AIoT device may BPSK-modulate the cosine waveform 901 having the first frequency shift value fₘ as a value ‘1’ when the cosine waveform is negative and as a value ‘0’ when the cosine waveform is positive. When the cosine waveform 901 having the first frequency shift value fₘ is BPSK-modulated into BPSK bits in the symbol duration Tₛ in which the carrier wave signal is transmitted, the cosine waveform 901 having the first frequency shift value fₘ may become a digital value such as ‘1010’. The BPSK value ‘1010’ illustrated in FIG. 9A is provided merely for facilitating understanding of the present disclosure and is not intended to limit the present disclosure.

A duration Tₛ₁ in which the BPSK-modulated signal is maintained may be expressed as Equation 2 below.

$${T}_{s 1} = \frac{3 \times 1 {0}^{8}}{2 {f}_{m} t} \qquad [ Equation 2 ]$$

Meanwhile, in the example above, when the cosine waveform 901 having the first frequency shift value fₘ is BPSK-modulated, ‘1’ and ‘0’ may be configured to be modulated in reverse to the description above. In other words, the cosine waveform 901 having the first frequency shift value fₘ may be configured such that the cosine waveform is modulated as a value ‘0’ when negative and modulated as a value ‘1’ when positive. Such a configuration of modulated values may be defined between the TRP and the AIoT device or may be defined in the technical specifications.

The AIoT device may generate the cosine waveform 901 having the first frequency shift value fₘ and may acquire values BPSK-modulated based on the generated cosine waveform 901.

The AIoT device may modulate the received carrier wave signal by performing 180-degree phase switching (or conversion) in an on/off manner based on the BPSK-modulated value of the cosine waveform 901 having the first frequency shift value fₘ (S910). For example, when the BPSK-modulated value is ‘0’, the AIoT device may output the received carrier wave signal as is, and when the BPSK-modulated value is ‘1’, the AIoT device may output the received carrier wave signal by performing 180-degree phase switching (S910). Therefore, the signal modulated based on the method described above may be backscattered to the TRP, and the TRP may receive the backscattered signal y(t) 921.

As another example different from the description above, the AIoT device may modulate the received carrier wave signal by performing 180-degree phase switching (or conversion) according to a positive or negative duration of the generated cosine waveform 901 having the first frequency shift value fₘ without performing BPSK modulation. More specifically, in a negative duration of the cosine waveform 901 having the first frequency shift value fₘ, the AIoT device may output the received carrier wave signal as is, and in a positive duration of the cosine waveform 901 having the first frequency shift value fₘ, the AIoT device may output the received carrier wave signal by performing 180-degree phase switching.

In such a configuration, BPSK modulation may not be performed, and therefore a configuration complexity of the AIoT device may be reduced.

FIG. 9B is a conceptual diagram illustrating a modulation process when a bit value of an information bit string that an AIoT device intends to transmit is ‘1’.

When a bit value of an information bit string to be transmitted to the TRP is ‘1’, the AIoT device may generate a cosine waveform 902 having a second frequency shift value fₘ for representing information ‘1’. As illustrated in FIG. 9B, the cosine waveform 902 having the second frequency shift value fₘ, may be expressed as cos (2πf_{m′}t). The cosine waveform 902 having the second frequency shift value fₘ, may be BPSK-modulated.

As illustrated in FIG. 9B, the AIoT device may BPSK-modulate the cosine waveform 902 having the second frequency shift value fₘ, as a value ‘1’ when the cosine waveform is negative and as a value ‘0’ when the cosine waveform is positive. When the cosine waveform 902 having the second frequency shift value fₘ, is BPSK-modulated into BPSK bits in the symbol duration Tₛ in which the carrier wave signal is transmitted, the cosine waveform 902 having the second frequency shift value fₘ may become a digital value such as ‘1010’. In this case, a duration Tₛ₂ in which the BPSK-modulated signal is maintained may be expressed as Equation 3 below.

$${T}_{s 2} = \frac{3 \times 1 {0}^{8}}{2 {f}_{{m}^{′}} t} \qquad [ Equation 3 ]$$

The duration Tₛ₂ in which the BPSK-modulated signal is maintained in Equation 3 may be the same value as the duration Tₛ₁ in which the BPSK-modulated signal is maintained described above in Equation 2. As another example, the duration Tₛ₂ in which the BPSK-modulated signal is maintained may be a value different from the duration Tₛ₁ in which the BPSK-modulated signal is maintained described above in Equation 2.

Meanwhile, in the example above, when the cosine waveform 902 having the second frequency shift value fₘ, is BPSK-modulated, ‘1’ and ‘0’ may be configured to be modulated in reverse to the description above. In other words, the cosine waveform 902 having the second frequency shift value fₘ, may be configured such that the cosine waveform is modulated as a value ‘0’ when negative and modulated as a value ‘1’ when positive. Such a configuration of modulated values may be defined between the TRP and the AIoT device or may be defined in the technical specifications. The AIoT device may generate the cosine waveform 902 having the second frequency shift value fₘ, and may acquire values BPSK-modulated based on the generated cosine waveform 902.

The AIoT device may modulate the received carrier wave signal by performing 180-degree phase switching (or conversion) in an on/off manner based on the BPSK-modulated value for the cosine waveform 902 having the second frequency shift value fₘ, (S920). For example, when a BPSK-modulated value is ‘0’, the AIoT device may output the received carrier wave signal as is, and when a BPSK-modulated value is ‘1’, the AIoT device may output the received carrier wave signal by performing 180-degree phase switching.

As another example different from the description above, the AIoT device may modulate the received carrier wave signal by performing 180-degree phase switching (or conversion) according to a positive or negative duration of the generated cosine waveform 902 having the second frequency shift value fₘ, without performing BPSK modulation. More specifically, in a negative duration of the cosine waveform 902 having the second frequency shift value fₘ, the AIoT device may output the received carrier wave signal as is, and in a positive duration of the cosine waveform 902 having the second frequency shift value fₘ″, the AIoT device may output the received carrier wave signal by performing 180-degree phase switching.

A signal-allocation form in the frequency domain when the TRP receives the modulated and backscattered signal from the AIoT device in step S504 is described with reference to FIGS. 9C and 9D.

FIG. 9C is a conceptual diagram illustrating subcarriers of an AIoT group received at a TRP when a bit value of an information bit string that an AIoT device transmits is ‘0’.

As described above with reference to FIG. 6C, the AIoT device may set an information bit value to be transmitted on a data-transmission subcarrier 930 among A subcarriers included in the second AIoT group 605. The exemplary embodiment of FIG. 9C may correspond to a case where the information bit value to be transmitted is ‘0’. Therefore, the AIoT device may allocate a value (or symbol) for the information bit value ‘0’ to the data-transmission subcarrier 930 among the subcarriers in the second AIoT group 605. The value (or symbol) for the information bit value ‘0’ may be a first-modulated value. As a modulation scheme therefor, the OOK modulation scheme described above or another modulation scheme having low complexity may be used. The AIoT device may frequency-shift the data-transmission subcarrier 930 by a first frequency shift value fₘ. A shifted data-transmission subcarrier 931, which is obtained by frequency-shifting the data-transmission subcarrier 930 by the first frequency shift value fₘ, may be a subcarrier spaced apart from the data-transmission subcarrier 930 by the first frequency shift value fₘ.

In a general communication system, when subcarriers that are frequency-shifted by the first frequency shift value fₘ are transmitted, a signal corresponding to the information bit value ‘0’ may also be generated on a subcarrier 932 that is located symmetrically in the opposite direction by the same frequency shift amount, in addition to the desired frequency-shifted subcarrier 931. This phenomenon is referred to as Hermitian symmetry. Due to Hermitian symmetry, the signal corresponding to the information bit value ‘0’ may be generated on the subcarrier 932 symmetric to the shifted data-transmission subcarrier 931.

FIG. 9C also illustrates a case where, due to Hermitian symmetry, data is transmitted on additional subcarriers 933 and 934 beyond the symmetric subcarriers. FIG. 9C shows an example in which data is transmitted on subcarriers located at +3 times the first frequency shift value fₘ. In practice, a signal may also be transmitted on subcarriers located at +5 times the first frequency shift value fₘ.

The frequency-shift procedure may generate the first frequency shift value fₘ by using a local oscillator (LO) and may generate a frequency-shifted signal by mixing subcarriers with the generated first frequency shift value fₘ. In other words, when frequency shifting is performed by using the LO, the data-transmission subcarrier 930 may be frequency-shifted to the subcarrier 931, which is frequency-shifted by the first frequency shift value fₘ, and may be frequency-shifted to the subcarrier 932, which is frequency-shifted in a negative direction by the first frequency shift value fₘ.

However, since the present disclosure considers an AIoT device having low complexity, the LO is not used. In other words, as described above, a pseudo frequency-shifted signal is generated through OOPS modulation. Therefore, in subcarriers included in the second AIoT group 605 OOPS-modulated by the AIoT device according to the present disclosure, a signal may be generated on the subcarriers 933 and 934 at +3 times the first frequency shift value fₘ from the data-transmission subcarrier 930 and on subcarriers at +5 times the first frequency shift value fₘ (not illustrated in FIG. 9C).

The subcarriers 933 and 934 located at +3 times the first frequency shift value fₘ and the subcarriers located at +5 times the first frequency shift value fₘ, as illustrated in the present disclosure, may correspond to theoretically derived frequency multiples of ‘3’ and ‘5’. Therefore, in an actual wireless environment, a multiple value at the time of OOPS modulation may be a value different from the theoretical value. Even when the multiple value has a value different from the theoretical value, the present disclosure described above may be applied.

Meanwhile, a signal transmitted on a subcarrier frequency-shifted by the first frequency shift value fₘ for the data-transmission subcarrier by the AIoT device may have a specific power value or power level. In this case, a signal value transmitted on the frequency-shifted subcarrier may have the same power value as a signal configured on the data-transmission subcarrier by the AIoT device, which is hereinafter referred to as a first power value. However, a power level of a signal transmitted through the subcarriers 933 and 934 at +3 times the first frequency shift value fₘ and the subcarriers at +5 times the first frequency shift value fₘ may have a power value different from the first power value.

Among subcarriers of the AIoT group received at the TRP, a signal strength of subcarriers on which no data is transmitted may have a value of zero. In FIG. 9C, in order to represent this, a received strength on subcarriers on which no data is transmitted is illustrated as “Y(k)=0”. In addition, a received signal strength through the frequency-shifted subcarriers 931 and 932 is denoted as “Y(k)=β”.

As described above, a received signal strength through the subcarriers 933 and 934 at +3 times the first frequency shift value fₘ additionally generated in addition to the frequency-shifted subcarriers 931 and 932 is illustrated as “Y(k)=γβ”. Although not illustrated in FIG. 9C, a received signal strength through subcarriers at +5 times the first frequency shift value fₘ, in a case where the corresponding subcarriers exist, may be expressed as “Y(k)=y′β”.

In the example of FIG. 9C, the signal strength may correspond to a case where fading is 1, no noise is added, and only path loss occurs in order to facilitate understanding of the present disclosure. However, in a wireless communication environment, fading may occur and noise may be added. Even in such an actual environment, the second exemplary embodiment of the present disclosure described above may be applied.

FIG. 9D is a conceptual diagram illustrating subcarriers of an AIoT group received at a TRP when a bit value of an information bit string that an AIoT device transmits is ‘1’.

The exemplary embodiment of FIG. 9D may correspond to a case where an information bit value to be transmitted is ‘1’. The AIoT device may allocate a value (or symbol) for an information bit value ‘1’ to a data-transmission subcarrier 940 among subcarriers in the second AIoT group 605. In FIG. 9D, a different reference numeral from that of the data-transmission subcarrier 930 described in FIG. 9C is used. The use of the different reference numeral is for facilitating understanding of frequency shifting described below, and the data-transmission subcarrier 940 may be the same subcarrier as described above. In other words, when only one subcarrier in the second AIoT group 605 is configured as a data-transmission subcarrier, the data-transmission subcarrier 930 described in FIG. 9C and the data-transmission subcarrier 940 using a different reference numeral in FIG. 9D may be the same subcarrier.

The value (or symbol) for the information bit value ‘1’ may be a first-modulated value. As a modulation scheme therefor, the OOK modulation scheme described above or another modulation scheme having low complexity may be used. The AIoT device may frequency-shift the data-transmission subcarrier 940 by a second frequency shift value f_{m′}. The second frequency shift value fₘ, may be a value different from the first frequency shift value fₘ described above with reference to FIG. 9C.

When subcarriers frequency-shifted by the second frequency shift value fₘ are transmitted by frequency-shifting the data-transmission subcarrier 940 by the second frequency shift value fₘ, as described above, a signal of the value (or symbol) for the information bit value ‘0’ may be generated on a subcarrier spaced apart in an opposite direction by the second frequency shift value fₘ, from the data-transmission subcarrier. In addition, since the AIoT device according to the present disclosure generates pseudo frequency-shifted signals through OOPS modulation, frequency-shifted signals may be generated on subcarriers 943 and 944 at +3 times the second frequency shift value fₘ, and frequency-shifted signals may be generated on subcarriers at +5 times the second frequency shift value fₘ, (not illustrated in FIG. 9D).

As described above with reference to FIG. 9C, the subcarriers 943 and 944 at ±3 times the second frequency shift value fₘ, and the subcarriers at ±5 times the second frequency shift value fₘ, may correspond to theoretically derived frequency multiples of ‘3’ and ‘5’, and in an actual wireless environment, a multiple value at the time of OOPS modulation may be a value different from the theoretical value.

Meanwhile, a signal transmitted on a subcarrier frequency-shifted by the second frequency shift value fₘ, for the data-transmission subcarrier by the AIoT device may have a power equal to that of a signal configured for the data-transmission subcarrier by the AIoT device, which is hereinafter referred to as a first power value. In this case, the first power value described in FIG. 9C and the first power value described in FIG. 9D may be the same power value. In addition, a power level of a signal transmitted through the subcarriers 933 and 934 at ±3 times the second frequency shift value fₘ, and the subcarriers at ±5 times the second frequency shift value fₘ, may have a power value different from the first power value.

The signal strength of subcarriers on which data is not transmitted among subcarriers of the AIoT group received at the TRP may correspond to a case in which no power is allocated, such as “Y(k)=0”. In contrast, the signal strength received through frequency-shifted subcarriers 931, 932 may have a power level such as “Y(k)=β”, and the signal strength received through subcarriers 943, 944 at ±3 times the second frequency shift value fₘ, may have a power level such as “Y(k)=γβ”. In addition, although not illustrated in FIG. 9C, the signal strength received through subcarriers at ±5 times the second frequency shift value fₘ, (when such subcarriers exist) may be expressed as “Y(k)=y′B′”.

FIG. 9D also illustrates the signal strength when fading is 1, noise is not added, and only path loss occurs, as described above with respect to FIG. 9C. However, even in an actual environment, the second exemplary embodiment of the present disclosure may be applied.

As described in FIG. 9C and/or FIG. 9D, the TRP receiving the subcarriers of the second AIoT group 605 may detect an information bit value by determining which subcarrier exhibits a detected signal strength for data intended to be transmitted by the AIoT device. This may allow the bit value to be detected more easily because a frequency shift value differs depending on the bit value of the information bit string.

### Third Exemplary Embodiment

The third exemplary embodiment described below may correspond to a case in which data to be transmitted is configured as an information bit string, the AIoT device transmits the information bit string, and the AIoT device modulates and transmits one bit per symbol duration. A procedure for transmitting a backscattered signal from the AIoT device to the TRP according to the third exemplary embodiment of the present disclosure is described again with reference to FIG. 5.

In step S500, the TRP may transmit a carrier wave signal to the AIoT device. Therefore, in step S500, the AIoT device may receive the carrier wave signal from the TRP. The carrier wave signal may indicate a time-domain signal as described above with reference to FIG. 7.

In step S502, the AIoT device may modulate a bit value of each bit of the information bit string to be transmitted to the TRP. When a bit value to be transmitted is ‘0’, the AIoT device may perform OOK(1) modulation. In other words, the AIoT device may modulate the bit value in the same manner as in the case in which the bit value ‘l’ is transmitted in the OOK modulation scheme described above. The OOK(1)-modulated symbol may be allocated to a data-transmission subcarrier located at a center among subcarriers of the AIoT group.

When a bit value to be transmitted to the TRP is ‘1’, the AIoT device may perform second modulation based on the OOPS modulation scheme. In this case, the OOPS modulation may be performed as one of the OOPS(0) modulation scheme corresponding to the case in which a bit value to be transmitted is ‘0’, or the OOPS(1) modulation scheme corresponding to the case in which a bit value to be transmitted is ‘1’. When modulation is performed by OOPS(0) and/or OOPS(1) in this manner, the modulated symbol may be transmitted through a subcarrier frequency-shifted from the data-transmission subcarrier located at the center among subcarriers of the AIoT group, and through other subcarriers that appear due to the frequency shift. This may occur because the AIoT device does not use an LO, as described above. In addition, in the present disclosure, a reason for transmitting the bit value ‘1’ through modulation using OOPS(0) and/or OOPS(1) may be to obtain a diversity combining and/or selection gain in demodulation of the signal received at the TRP.

Thereafter, in step S502, the AIoT device may backscatter the carrier wave signal by applying the subcarriers of the AIoT group including the modulated symbols.

In step S504, the AIoT device may transmit the modulated and backscattered signal to the TRP. In step S504, the TRP may receive the modulated and backscattered signal from the AIoT device.

When the TRP detects a signal level only at the data-transmission subcarrier located at the center among subcarriers of the AIoT group in the signal received through backscattering, the TRP may determine that the AIoT device has transmitted a bit ‘0’. In addition, when the TRP detects a signal level at a subcarrier other than the data-transmission subcarrier among the subcarriers of the AIoT group or at a subcarrier frequency-shifted based on the OOPS scheme in the received and backscattered signal, the TRP may determine that the AIoT device has transmitted a bit ‘1’.

The third exemplary embodiment of the present disclosure described above may correspond to a scheme in which the AIoT device transmits a bit value to the TRP by using two different modulation schemes when the AIoT device transmits an information bit string in units of one bit. Therefore, a case in which two modulation schemes are used in this manner is referred to as a ‘composite modulation scheme’.

### Fourth Exemplary Embodiment

The fourth exemplary embodiment described below may correspond to a case in which data to be transmitted is configured as an information bit string, the AIoT device transmits the information bit string, and the AIoT device modulates and transmits one bit per symbol duration, as described above. A procedure for transmitting a backscattered signal from the AIoT device to the TRP according to the fourth exemplary embodiment of the present disclosure is described again with reference to FIG. 5.

In step S500, the TRP may transmit a carrier wave signal to the AIoT device. Therefore, in step S500, the AIoT device may receive the carrier wave signal from the TRP. The carrier wave signal may refer to a time-domain signal as described above with reference to FIG. 7.

In step S502, the AIoT device may modulate each bit value of the information bit string to be transmitted to the TRP. When a bit value to be transmitted is ‘0’, the AIoT device may perform OOK(1) modulation. In other words, the AIoT device may modulate the bit value in the same manner as in the case in which the bit value ‘1’ is transmitted in the OOK modulation scheme described above. In addition, in the fourth exemplary embodiment, the AIoT device may further perform OOPS(0) modulation on the OOK(1)-modulated symbol in order to obtain a diversity combining gain. In other words, the AIoT device may modulate the bit value ‘0’ by the composite modulation scheme.

The OOPS(0) modulation may be a scheme in which a data-transmission subcarrier frequency-shifted by the first frequency shift value fₘ is transmitted as described above in the second exemplary embodiment. Therefore, the AIoT device may transmit the OOK(1)-modulated symbol through a data-transmission subcarrier frequency-shifted by the first frequency shift value fₘ. In this case, because the modulated symbol is transmitted using the OOPS scheme, the OOK(1)-modulated symbol may be transmitted together through a subcarrier frequency-shifted negatively by the first frequency shift value fₘ, through subcarriers at ±3 times the first frequency shift value fₘ, and through subcarriers at ±5 times the first frequency shift value fₘ, as described above with respect to FIG. 9C.

In contrast, when a bit value to be transmitted to the TRP is ‘1’, the AIoT device may perform OOK(1) modulation. In the fourth exemplary embodiment, the AIoT device may further perform OOPS(1) modulation on the OOK(1)-modulated symbol in order to obtain a diversity combining gain. In other words, the AIoT device may modulate the bit value ‘1’ by the composite modulation scheme.

The OOPS(1) modulation may also be a scheme in which a data-transmission subcarrier frequency-shifted by a second frequency shift value fₘ, is transmitted as described above in the second exemplary embodiment. Therefore, the AIoT device may transmit the OOK(1)-modulated symbol through a data-transmission subcarrier frequency-shifted by the second frequency shift value f_{m′}. In this case, because the modulated symbol is transmitted using the OOPS scheme, the OOK(1)-modulated symbol may be transmitted together through a subcarrier frequency-shifted negatively by the second frequency shift value f_{m′}, through subcarriers at ±3 times the second frequency shift value f_{m′}, and through subcarriers at ±5 times the second frequency shift value f_{m′}, as described above with respect to FIG. 9C.

Thereafter, in step S502, the AIoT device may backscatter the carrier wave signal by applying the subcarriers of the AIoT group including the modulated symbols.

In step S504, the AIoT device may transmit the modulated and backscattered signal to the TRP. In step S504, the TRP may receive the modulated and backscattered signal from the AIoT device.

The TRP may determine a bit value transmitted by the AIoT device by identifying subcarriers at which a signal level of OOK(1) is detected with respect to subcarriers of the AIoT group. For example, when a signal level is detected at subcarriers corresponding to the first frequency shift value, the TRP may determine that the AIoT device has transmitted a bit ‘0’, and when a signal level is detected at subcarriers corresponding to the second frequency shift value, the TRP may determine that the AIoT device has transmitted a bit ‘1’.

### Fifth Exemplary Embodiment

The fifth exemplary embodiment described below may correspond to a case in which data to be transmitted is configured as an information bit string as described above, and the AIoT device transmits the information bit string by modulating two bits per one symbol duration. According to the fifth exemplary embodiment of the present disclosure, a procedure in which a backscattered signal is transmitted from the AIoT device to the TRP is described with reference again to FIG. 5 described above.

In step S500, the TRP may transmit a carrier wave signal to the AIoT device. Therefore, in step S500, the AIoT device may receive the carrier wave signal from the TRP. The carrier wave signal may refer to a time-domain signal as described above with reference to FIG. 7.

In step S502, the AIoT device may modulate an information bit string to be transmitted to the TRP in units of two bits. Four cases of a two-bit value to be transmitted to the TRP by the AIoT device may exist as follows: a case of a two-bit value ‘00’ (Case #1), a case of a two-bit value ‘01’ (Case #2), a case of a two-bit value ‘10’ (Case #3), and a case of a two-bit value ‘11’ (Case #4).

In Case #1, the AIoT device may perform OOK(1) modulation as described in the second exemplary embodiment above. In other words, the AIoT device may modulate in the same manner as in the case in which a bit value to be transmitted is ‘1’ among the OOK modulation schemes described above. The OOK(1)-modulated symbol may be allocated to a data-transmission subcarrier located at a center among subcarriers of an AIoT group.

In Case #2, the AIoT device may use one of OOPS(0) modulation, which is a modulation scheme for a bit value ‘0’, and OOPS(1) modulation, which is a modulation scheme for a bit value ‘1’, to obtain a diversity selection gain as described in the third exemplary embodiment. In another example, in Case #2, to obtain a diversity selection gain, the AIoT device may alternately allocate an OOPS(0)-modulated symbol and an OOPS(1)-modulated symbol in one symbol duration.

In Case #3, the AIoT device may configure a symbol obtained by combining (adding) an OOPS(0)-modulated symbol and an OOPS(1)-modulated symbol, as described in the third exemplary embodiment, to obtain a diversity combining gain, and may allocate the symbol within an AIoT group during one symbol duration.

In Case #4, the AIoT device may allocate one of a symbol obtained by combining (adding) an OOK(1)-modulated symbol and an OOPS(0)-modulated symbol, or a symbol obtained by combining (adding) an OOK(1)-modulated symbol and an OOPS(1)-modulated symbol within an AIoT group during one symbol duration, in order to obtain a diversity combining and/or selection gain. In another exemplary embodiment of Case #4, to obtain a diversity combining and/or selection gain, the AIoT device may alternately allocate, within one symbol duration in an AIoT group, a symbol obtained by combining (adding) an OOK(1)-modulated symbol and an OOPS(0)-modulated symbol, and a symbol obtained by combining (adding) an OOK(1)-modulated symbol and an OOPS(1)-modulated symbol.

In step S502, the AIoT device may backscatter the carrier wave signal by applying the subcarriers of the AIoT group including modulated symbols.

In step S504, the AIoT device may transmit the modulated and backscattered signal to the TRP. In step S504, the TRP may receive the modulated and backscattered signal from the AIoT device.

The TRP may determine whether the AIoT device has transmitted a bit value ‘00’, a bit value ‘01’, a bit value ‘10’, or a bit value ‘11’ by detecting a transmission scheme through subcarriers of the AIoT group in the backscattered signal.

When the modulated symbols are transmitted through backscattering as in the composite modulation scheme described in the fifth exemplary embodiment, two bits may be transmitted in one symbol. Therefore, when comparing the first to fourth exemplary embodiments in which only one bit is transmitted in one symbol duration with the fifth exemplary embodiment in which two bits are transmitted in one symbol duration, the fifth exemplary embodiment may have a data-transmission rate increased by two times compared to the data-transmission rates of the exemplary embodiments described above.

### Sixth Exemplary Embodiment

The sixth exemplary embodiment described below may correspond to a case where data to be transmitted is also configured as an information bit string as described above with reference to the fifth exemplary embodiment, and the AIoT device transmits the information bit string by modulating two bits per one symbol duration. According to the sixth exemplary embodiment of the present disclosure, a procedure in which a backscattered signal is transmitted from the AIoT device to the TRP is described with reference to FIG. 5 described above.

In step S500, the TRP may transmit a carrier wave signal to the AIoT device. Therefore, in step S500, the AIoT device may receive the carrier wave signal from the TRP. The carrier wave signal may refer to a time-domain signal as described above with reference to FIG. 7.

In step S502, the AIoT device may modulate an information bit string to be transmitted to the TRP in units of two bits. Four cases of a two-bit value to be transmitted to the TRP by the AIoT device may exist as follows: a case of a two-bit value ‘00’ (Case #1), a case of a two-bit value ‘01’ (Case #2), a case of a two-bit value ‘10’ (Case #3), and a case of a two-bit value ‘11’ (Case #4).

In Case #1, the AIoT device may perform OOK(0) modulation as described in the second exemplary embodiment. In other words, the AIoT device may modulate in the same manner as in the case in which a bit value to be transmitted is ‘0’ among the OOK modulation schemes described above. The OOK(0)-modulated symbol may be allocated to a data-transmission subcarrier located at a center among subcarriers of an AIoT group.

In Case #2, the AIoT device may perform OOK(1) modulation as described in the second exemplary embodiment. In other words, the AIoT device may modulate in the same manner as in the case in which a bit value to be transmitted is ‘1’ among the OOK modulation schemes described above. The OOK(1)-modulated symbol may be allocated to a data-transmission subcarrier located at a center among subcarriers of an AIoT group.

In Case #3, the AIoT device may perform OOPS(0) modulation as described in the third exemplary embodiment. In other words, in Case #3, the AIoT device may perform the modulation such that modulated symbols for a bit value ‘0’ are allocated to subcarriers during one symbol duration.

In Case #4, the AIoT device may perform OOPS(1) modulation as described in the third exemplary embodiment. In other words, in Case #4, the AIoT device may perform the modulation such that modulated symbols for a bit value ‘1’ are allocated to subcarriers during one symbol duration.

In step S502, the AIoT device may backscatter the carrier wave signal by applying subcarriers of the AIoT group including the modulated symbols.

In step S504, the AIoT device may transmit the modulated and backscattered signal to the TRP. In step S504, the TRP may receive the modulated and backscattered signal from the AIoT device.

The TRP may determine whether the AIoT device has transmitted a bit value ‘00’, a bit value ‘01’, a bit value ‘10’, or a bit value ‘11’ by detecting the symbols received through the subcarriers of the AIoT group in the backscattered signal.

In the case of the sixth exemplary embodiment, two bits may be transmitted in one symbol as described above with reference to the fifth exemplary embodiment. Therefore, when comparing the first to fourth exemplary embodiments in which only one bit is transmitted in one symbol duration with the sixth exemplary embodiment in which two bits are transmitted in one symbol duration, the sixth exemplary embodiment may have a data-transmission rate increased by two times compared to the data-transmission rates of the exemplary embodiments described above.

In addition to the forms described above, one bit or two or more bits may be configured to be transmitted in one symbol duration of backscattering by combining OOK(0), OOK(1), OOPS(0), and OOPS(1) modulations in various forms. The modified combinations of the forms described above may be combined without particular effort by a person skilled in the art based on the descriptions above.

Meanwhile, in the OOPS modulation described above, only a case in which a frequency shift (variation) is performed based on a bit value of one bit to be transmitted has been described as an example, but four different frequency shifts based on a two-bit value may also be possible. This concept may be extended to three-bit values or more.

Meanwhile, the method described above has been described only with respect to a case in which information collected by one AIoT device is transmitted to the TRP. However, information collected by two or more AIoT devices may also be transmitted to the TRP based on the method described above. When two or more AIoT devices attempt to transmit at the same time, each AIoT device may transmit (backscatter) modulated symbols to the TRP by using a frequency division/hopping multiplexing (FDHM) scheme. Through this, collisions caused by different AIoT devices transmitting data through the same subcarrier group may be avoided.

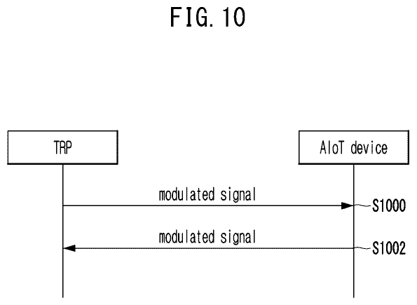

FIG. 10 is a sequence chart illustrating a case in which a TRP and an AIoT device transmit collected information to a counterpart side.

In step S1000, a TRP may modulate collected information and may transmit the modulated information to an AIoT device. The modulated signal may be transmitted through a carrier wave signal. The carrier wave signal may be a cosine-wave signal as described above with reference to FIG. 7. In other words, the carrier wave signal may be a signal described in Equation 1. The TRP may transmit, to the AIoT device, the information to be transmitted to the AIoT device by applying the information to the carrier wave signal based on one of the first to sixth exemplary embodiments described above. The operations of the first to sixth exemplary embodiments have been described as operations based on the AIoT device. Using such an information transmission method, the TRP may transmit to the AIoT device the carrier wave signal including the modulated signal.

In step S1000, the AIoT device may receive the carrier wave signal from the TRP and may detect whether information is included in the received carrier wave signal by detecting whether the TRP performs information transmission in the same manner as in the first to sixth exemplary embodiments. When information is transmitted, the AIoT device may identify bit values included in the carrier wave signal and may identify the information that the TRP intended to transmit to the AIoT device.

In step S1002, the AIoT device may modulate collected information and may transmit the modulated information to the TRP. When modulating the collected information, the AIoT device may generate a carrier wave signal by converting a frequency fc generated by the AIoT device into a cosine-wave signal such as in Equation 1. In addition, the AIoT device may transmit the modulated signal generated through one of the first to sixth exemplary embodiments described above by applying the modulated signal to the carrier wave signal.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving, from a base station, a carrier wave signal including subcarriers belonging to a sensing group within a system bandwidth;
modulating pre-collected information based on receiving the carrier wave signal; and
backscattering, to the base station, the carrier wave signal including the subcarriers of the sensing group,
wherein at least one subcarrier among the subcarriers of the sensing group transmitted through the backscattered carrier wave signal includes the modulated information, and the subcarriers of the sensing group include a data-transmission subcarrier on which the modulated information is transmitted and a non-data-transmission subcarrier on which the modulated information is not transmitted.

2. The method of claim 1, wherein the modulated information is transmitted in units of a predetermined symbol unit.

3. The method of claim 1, wherein the pre-collected information is configured as a bit string, each bit of the bit string is modulated, and each bit of the bit string has either a first value or a second value; based on a bit having the first value, the data-transmission subcarrier is modulated to be shifted by a first frequency; and based on a bit having the second value, the data-transmission subcarrier is modulated to be shifted by a second frequency.

4. The method of claim 1, wherein the pre-collected information is configured as a bit string, each bit of the bit string is modulated, and each bit of the bit string has either a first value or a second value; based on a bit having the first value, the bit having the first value is modulated into a symbol corresponding to the second value and is allocated to the data-transmission subcarrier; and based on a bit having the second value, the data-transmission subcarrier is modulated to be shifted by a first frequency.

5. The method of claim 1, wherein the pre-collected information is configured as a bit string, each bit of the bit string is modulated, and each bit of the bit string has either a first value or a second value; based on a bit having the first value, first modulation is performed such that the bit having the first value is modulated into a symbol corresponding to the second value, and second modulation is performed such that the data-transmission subcarrier is modulated to be shifted by a first frequency; and based on a bit having the second value, third modulation is performed such that the data-transmission subcarrier is modulated to be shifted by a second frequency.

6. The method of claim 1, wherein the pre-collected information is configured as a bit string, and each bit of the bit string is modulated, and the backscattering comprises: enabling or disabling a backscattering operation based on a value of each bit of the bit string.

7. The method of claim 1, wherein the pre-collected information is configured as a bit string, every two bits of the bit string are modulated, the two bits have one of a first value, a second value, a third value, or a fourth value; one or more values among the first value, the second value, the third value, or the fourth value are modulated using two types of modulation schemes, and a symbol modulated for every two bits is transmitted in units of a predetermined symbol unit.

8. The method of claim 7, wherein the two types of modulation schemes include at least one of an on-off keying (OOK) modulation scheme or an on-off 180-degree phase switching (OOPS) modulation scheme.

9. A terminal comprising at least one processor, wherein the at least one processor causes the terminal to perform:
receiving, from a base station, a carrier wave signal including subcarriers belonging to a sensing group within a system bandwidth;
modulating pre-collected information based on receiving the carrier wave signal; and
backscattering, to the base station, the carrier wave signal including the subcarriers of the sensing group,
wherein at least one subcarrier among the subcarriers of the sensing group transmitted through the backscattered carrier wave signal includes the modulated information, and the subcarriers of the sensing group include a data-transmission subcarrier on which the modulated information is transmitted and a non-data-transmission subcarrier on which the modulated information is not transmitted.

10. The terminal of claim 9, wherein the modulated information is transmitted in units of a predetermined symbol unit.

11. The terminal of claim 9, wherein the pre-collected information is configured as a bit string, each bit of the bit string is modulated, and each bit of the bit string has either a first value or a second value, and the at least one processor further causes the terminal to perform:
based on a bit having the first value, modulating the data-transmission subcarrier to be shifted by a first frequency; and
based on a bit having the second value, modulating the data-transmission subcarrier to be shifted by a second frequency.

12. The terminal of claim 9, wherein the pre-collected information is configured as a bit string, each bit of the bit string is modulated, and each bit of the bit string has either a first value or a second value, and the at least one processor further causes the terminal to perform:
based on a bit having the first value, modulating the bit having the first value into a symbol corresponding to the second value and allocating the symbol to the data-transmission subcarrier; and
based on a bit having the second value, modulating the data-transmission subcarrier to be shifted by a first frequency.

13. The terminal of claim 9, wherein the pre-collected information is configured as a bit string, each bit of the bit string is modulated, and each bit of the bit string has either a first value or a second value, and the at least one processor further causes the terminal to perform:
based on a bit having the first value, performing first modulation such that the bit having the first value is modulated into a symbol corresponding to the second value, and performing second modulation such that the data-transmission subcarrier is modulated to be shifted by a first frequency; and
based on a bit having the second value, performing third modulation such that the data-transmission subcarrier is modulated to be shifted by a second frequency.

14. The terminal of claim 9, wherein the pre-collected information is configured as a bit string, each bit of the bit string is modulated, and in the backscattering, the at least one processor causes the terminal to perform: enabling or disabling a backscattering operation based on a value of each bit of the bit string.

15. The terminal of claim 9, wherein the pre-collected information is configured as a bit string, every two bits of the bit string are modulated, the two bits have one of a first value, a second value, a third value, or a fourth value, and the at least one processor further causes the terminal to perform:
modulating one or more values among the first value, the second value, the third value, or the fourth value using two types of modulation schemes, and
transmitting a symbol modulated for every two bits in units of a predetermined symbol unit.

16. The terminal of claim 15, wherein the two types of modulation schemes include at least one of an on-off keying (OOK) modulation scheme or an on-off 180-degree phase switching (OOPS) modulation scheme.

17. A method of a base station, comprising:
broadcasting, through a carrier wave signal, subcarriers belonging to a sensing group within a system bandwidth;
receiving, from a terminal, a backscattered signal including modulated information; and
detecting the modulated information in units of a predetermined symbol unit,
wherein the subcarriers of the sensing group include a data-transmission subcarrier on which the modulated information is transmitted and a non-data-transmission subcarrier on which the modulated information is not transmitted, and
wherein the modulated information is in units of one bit.

18. The method of claim 17, wherein the detecting of the modulated information comprises:
determining the modulated information as a first value based on the backscattered signal not being received; and
determining the modulated information as a second value based on the backscattered signal being received.

19. The method of claim 17, wherein the detecting of the modulated information comprises:
detecting the modulated information as a first value based on a subcarrier on which data is present among subcarriers in the backscattered signal being shifted by a first frequency from the data-transmission subcarrier; and
detecting the modulated information as a second value based on a subcarrier on which data is present among the subcarriers in the backscattered signal being shifted by a second frequency from the data-transmission subcarrier.

20. The method of claim 17, wherein the detecting of the modulated information comprises:
detecting the modulated information as a first value based on detecting that data is present on the data-transmission subcarrier among subcarriers in the backscattered signal; and
detecting the modulated information as a second value based on detecting that data is present on a subcarrier shifted by a first frequency from the data-transmission subcarrier among the subcarriers in the backscattered signal.
